(19) United States
(12) Patent Application Publication
(10) Pub. No.: US 2025/0390331 A1
(43) Pub. Date: Dec. 25, 2025

(54) METHOD AND DEVICE FOR LIVE MIGRATION OF VIRTUAL MACHINE

(71) Applicant: Beijing Volcano Engine Technology Co., Ltd., Haidian District (CN)

(72) Inventor: Zhimin Feng, Beijing (CN)

(21) Appl. No.: 19/174,271

(22) Filed: Apr. 9, 2025

(30) Foreign Application Priority Data
Jun. 20, 2024 (CN) 202410804942.9

(51) Int. Cl. G06F 9/455

(52) U.S. Cl. CPC G06F 9/45558; G06F 2009/4557

(57) ABSTRACT

A method comprises: adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side; intercepting, in response to receiving the sleep instruction for a target VCPU thread, the sleep instruction, wherein the target VCPU thread is of a plurality of VCPU threads running in the virtual machine; exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

### CROSS-REFERENCE TO RELATED APPLICATION(S)

This application claims priority to Chinese Application No. 202410804942.9 filed in Jun. 20, 2024, the disclosure of which is incorporated herein by reference in its entirety.

### FIELD

Embodiments of the present disclosure relate to the field of cloud computing, in particular to a method and a device for live migration of a virtual machine.

### BACKGROUND

Live migration of a virtual machine (VM for short) is a very important operation and maintenance function in cloud computing. Live migration refers to moving a VM from one host to run on another host and the migration procedure would not be sensed by user service (there is no need to stop the VM). The principle of the live migration is to dynamically copy RAM and device state of the VM to a further host, to enable the VM to normally operate on the further host.

During live migration, one or more migration threads are initiated to continuously copy the memory data of the VM to a destination host. In such case, redundant CPU resources may be additionally occupied to run the migration threads during live migration. Currently, with the emergence of DPU technology, the host no longer needs to reserve additional CPU resources and all CPUs on the host would be allocated to the VM for use.

### SUMMARY

Embodiments of the present disclosure provides a method and a device for live migration of a virtual machine.

In a first aspect, embodiments of the present disclosure provide a method for live migration of a virtual machine, comprising:
adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
intercepting, in response to receiving the sleep instruction for a target VCPU thread, the sleep instruction, wherein the target VCPU thread is any VCPU thread in a plurality of VCPU threads running in the virtual machine;
exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In a second aspect, embodiments of the present disclosure provide a device for live migration of a virtual machine, comprising:
an adjusting unit for, adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
an intercepting unit for, intercepting, in response to receiving the sleep instruction for a target VCPU thread, the sleep instruction, wherein the target VCPU thread is any VCPU thread in a plurality of VCPU threads running in the virtual machine;
a live migration unit for exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In a third aspect, embodiments of the present disclosure provide an electronic device: comprising: a processor and a memory;
where the memory stores computer-executable instructions;
the processor executes the computer-executable instructions stored in the memory, such that the at least one processor performs the method for live migration of the virtual machine according to the above first aspect and various possible designs thereof.

In a fourth aspect, embodiments of the present disclosure provide a computer-readable storage medium stored with computer-executable instructions, which computer-executable instructions, when executed by a processor, implement the method for live migration of the virtual machine according to the above first aspect and various possible designs thereof.

In a fifth aspect, embodiments of the present disclosure provide a computer program product comprising computer programs, which computer programs, when executed by a processor, implement the method for live migration of the virtual machine according to the above first aspect and various possible designs thereof.

Embodiments provide a method and a device for live migration of a virtual machine. The method comprises: adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side; intercepting, in response to receiving the sleep instruction for a target VCPU thread, the sleep instruction, wherein the target VCPU thread is any VCPU thread in a plurality of VCPU threads running in the virtual machine; exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine. In this technical solution, when the live migration operation is performed on the virtual machine, the sleep instruction is intercepted by the intercept switch, the idle target VCPU thread is exited from the client side to the host side, and the target VCPU thread is switched to the sleep state at the host side, to free up the CPU resources of the target VCPU thread for live migration of the virtual machine.

### BRIEF DESCRIPTION OF THE DRAWINGS

Brief introduction of the drawings required in the following description of the embodiments or the prior art are to be provided below to more clearly explain the technical solutions according to the embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic flowchart I of the method for live migration of the virtual machine provided by embodiments of the present disclosure;

FIG. 2 illustrates a schematic flowchart II of the method for live migration of the virtual machine provided by embodiments of the present disclosure;

FIG. 3 illustrates a schematic diagram I of the method for live migration of the virtual machine provided by embodiments of the present disclosure;

FIG. 4 illustrates a schematic diagram II of the method for live migration of the virtual machine provided by embodiments of the present disclosure;

FIG. 5 illustrates a structural diagram of a device for live migration of the virtual machine provided by embodiments of the present disclosure;

FIG. 6 illustrates a structural diagram of an electronic device provided by the embodiments of the present disclosure.

### DETAILED DESCRIPTION OF EMBODIMENTS

For a clearer understanding of objectives, technical solution and advantages of the embodiments of the present disclosure, the technical solution in the embodiments of the present disclosure is to be described clearly and completely below with reference to the drawings in the embodiments of the present disclosure. Apparently, the described embodiments are just a part of the embodiments of the present disclosure, rather than all of them. Other embodiments obtained by those skilled in the art without requiring any exercises of inventive work on the basis of the embodiments in the present disclosure all fall within the protection scope of the present disclosure.

Live migration of a virtual machine (VM for short) is a very important operation and maintenance function in cloud computing. Live migration refers to moving a VM from one host to run on another host and the migration procedure would not be sensed by user service (there is no need to stop the VM). The principle of the live migration is to dynamically copy RAM and device state of the VM to a further host, to enable the VM to normally operate on the further host.

During live migration, one or more migration threads are initiated to continuously copy the memory data of the VM to a destination host. In such case, redundant CPU resources may be additionally occupied to run the migration threads during live migration. Currently, with the emergence of DPU technology, the host no longer needs to reserve additional CPU resources and all CPUs on the host would be allocated to the VM for use.

Inventors discovered that the prior art at least has the following technical problems: when all CPUs on the host are allocated to the VM for use, all VMs are 100% in an operating state from the perspective of the host. If a live migration operation is performed on the VM at this moment, migration threads would only preempt the CPU resources of the VM, which degrades the performance of the VM.

It is to be explained that when the host is an idle state (no-load), the host may execute an HLT instruction or an MWAIT instruction to put the CPU of the host in a low-power consumption state; in case there is a task to be executed, the CPU will be woken up to perform a task program. In a virtualization scenario, the VM also has an idle state. At this moment, the VM may execute the HLT instruction or the MWAIT instruction to put the VCPU in the VM in a low-consumption state. Besides, to enhance the VM performance, the VM is allowed to execute the HLA/MWAIT instruction without exiting, so as to maintain a relatively low VM overhead. In such case, despite that the VM is in the idle state or not, the VCPU thread of the VM, when observed from the Host side, is always in a running state. Accordingly, the VCPU thread will occupy 100% of the CPU to run.

For the technical problem in the prior art, inventors formulated the following technical concepts: an intercept switch for intercepting a sleep instruction is pre-configured in the virtual machine. In case of a live migration thread, the intercept switch is turned on to intercept the sleep instruction. An idle target VCPU thread exits from the client side (i.e., Guest side) to the host side (i.e., Host side) and the target VCPU thread is switched to a sleep state at the Host side, so as to free up CPU resources of the VCPU thread for live migration of the virtual machine.

Embodiments of the present disclosure provides a method and a device for live migration of a virtual machine, to prevent migration threads from affecting the performance of the virtual machine.

Correspondingly, specific steps may include: first, adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side. Then, in response to receiving the sleep instruction for a target VCPU thread, the sleep instruction is intercepted, wherein the target VCPU thread is any VCPU thread in a plurality of VCPU threads running in the virtual machine; and the target VCPU thread exits from the client side to a host side, and the target VCPU thread is switched to a sleep state at a host side to free up the CPU resources of the target VCPU thread. In the end, the live migration thread is initiated via a scheduler at the host side and the live migration of the virtual machine is performed via the live migration thread using the CPU resources released by the target VCPU thread.

In this technical solution, when the live migration operation is performed on the virtual machine, the sleep instruction is intercepted by the intercept switch, the idle target VCPU thread is exited from the client side to the host side, and the target VCPU thread is switched to the sleep state at the host side, to free up the CPU resources of the target VCPU thread for live migration of the virtual machine. Therefore, the live migration thread is prevented from preempting the CPU resources of the VCPU thread of the virtual machine and the performance of the virtual machine is enhanced.

Detailed implementations of the method and device for live migration of the virtual machine involved in the embodiments of the present disclosure are described below. Some examples are provided for illustrative purpose, rather than limitations. The execution body of the method for live migration of the virtual machine involved the embodiments of the present disclosure may be an electronic device, such as terminal and server etc.

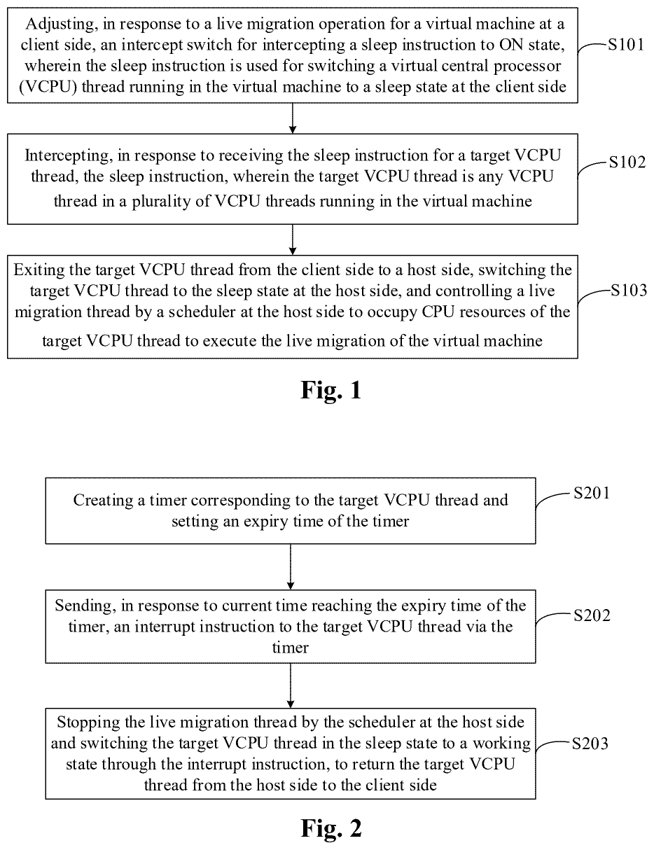

FIG. 1 illustrates a schematic flowchart I of the method for live migration of the virtual machine provided by embodiments of the present disclosure. As shown in FIG. 1, the method for live migration of the virtual machine may comprise:

S101: adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side.

In the embodiments of the present disclosure, an intercept switch denoted in dotted line may be configured in the virtual machine. The intercept switch, when in ON state, may intercept the sleep instruction, and the intercept switch, if in OFF state, will not intercept the sleep instruction.

Wherein the sleep instruction includes HLT (Processor Halt) sleep instruction and MWAIT (Processor Wait) sleep instruction.

The roles of the HLT sleep instruction and the MWAIT sleep instruction are to be introduced first. When the virtual machine is in the idle state, the sleep instruction may be executed to allow the VCPU thread of the virtual machine to enter an idle state (or low-consumption state). The sleep instructions may be called by an idle process (or swapper process in Linux system). In general, if the Linux system supports the MWAIT sleep instruction, the idle process is allowed to execute the MWAIT sleep instruction by default to enter the idle state; otherwise, the system enters the idle state using the HLT sleep instruction.

Then, the HLT sleep instruction and the MWAIT sleep instruction are used differently. Specifically, the HLT sleep instruction will enable the VCPU thread to enter a C1 state while the MWAIT instruction will enable the VCPU thread to enter a deeper Cx (C2 to C6) state. In addition, these sleep instructions wake up the idle process in various ways, wherein the HLT sleep instruction can only wake up the VCPU thread in the idle state by interrupt, whereas the MWAIT instruction may wake up the VCPU thread in the idle state by interrupt and also may wake up the VCPU thread in the idle state by the memory monitored by write monitor.

Wherein when the VCPU thread in the idle state is woken up by the memory monitored by write monitor, it may reduce one interrupt. This is also the reason for the idle process to execute the MWAIT sleep instruction by default to enter the idle state.

S102: intercepting, in response to receiving the sleep instruction for a target VCPU thread, the sleep instruction, wherein the target VCPU thread is any VCPU thread in a plurality of VCPU threads running in the virtual machine.

In the embodiments of the present disclosure, the intercept switch is turned on to intercept the HLT sleep instruction and the MWAIT sleep instruction.

S103: exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In the embodiments of the present disclosure, the purpose of exiting the target VCPU thread from the client side to the host side is to switch the target VCPU thread into the sleep state at the host side, so as to free up the CPU resources of the target VCPU thread for live migration of the virtual machine.

In the embodiments of the present disclosure, the live migration thread, which is initiated via the scheduler at the host side, runs at the host side and utilizes the CPU resources released by the target VCPU thread.

Embodiments of the present disclosure provide a method for live migration of the virtual machine, comprising: adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side; intercepting, in response to receiving the sleep instruction for a target VCPU thread, the sleep instruction, wherein the target VCPU thread is any VCPU thread in a plurality of VCPU threads running in the virtual machine; exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine. In this technical solution, when the live migration operation is performed on the virtual machine, the sleep instruction is intercepted by the intercept switch, the idle target VCPU thread is exited from the client side to the host side, and the target VCPU thread is switched to the sleep state at the host side, to free up the CPU resources of the target VCPU thread for live migration of the virtual machine. Therefore, the live migration thread is prevented from preempting the CPU resources of the VCPU thread of the virtual machine and the performance of the virtual machine is enhanced.

Moreover, when there is a task to be executed by the VCPU thread, it is required to wake up the VCPU thread and return the VCPU thread from the host side to the client side to execute the task. The main idea of the inventive solution includes: when the VM is executing the live migration, it is only required to enable the VCPU in the idle state to voluntarily give up the CPU resources for the migration thread to run; if the VCPU thread needs to run, it only needs to preempt the migration thread. Accordingly, in the full sales scenarios, the migration thread will not compete with the VCPU thread for CPU resources, so as to ensure that the performance of the VM is not affected.

The key point to be solved by this solution is how to enable the VCPU thread in the idle state to voluntarily give up the CPU resources while the normal function of the VM is ensured.

The HLT sleep instruction and the MWAIT sleep instruction wake up the idle process in different ways, wherein the HLT sleep instruction can only wake up the VCPU thread in the idle state through interrupt and the MWAIT sleep instruction may wake up the VCPU thread in the idle state by interrupt and also may wake up the VCPU thread in the idle state by the memory monitored by write monitor. Thus, two different solutions are provided for Guest using HLT/MWAIT instruction.

The first solution: when the Guest is using the HLT instruction, it is a scenario that can be easily handled; before the beginning of the migration, an intercept operation is directly performed on the HLT instruction; accordingly, upon execution of the HLT instruction, the Guest in the idle state would exit to the host side; meanwhile, the VCPU thread at the host side is set in the sleep state, and a scheduler of the Host schedules the migration thread for execution; when the Guest switches from the idle state to the running state, an interrupt will be sent to the corresponding

VCPU thread; at this moment, the scheduler at the host side wakes up the VCPU thread in the sleep state and directly preempts the running migration thread.

The second solution: when the Guest is using the MWAIT instruction, an intercept operation is also performed on the MWAIT instruction before the migration, to allow the VCPU thread to exit to the host side; if the VCPU thread is woken up by the interrupt, the second solution has the same implementation idea as the first solution of HLT.

However, if the VCPU thread in the idle state is woken up by the memory monitored by write monitor, the host side could not sense it. Accordingly, the VCPU thread at the host side could not be woken up and the VCPU thread could not be operated normally as expected.

For this, the present invention proposes the following solution: in case that the VCPU thread executes the MWAIT instruction to exit to the host side to give up the CPU resources, a Timer is created and an expiry time of the timer may be set to a fixed time (such as 1 ms, 2 ms and 4 ms etc.). As such, when the timer expires, a timer interrupt may be sent to the VCPU thread and the VCPU thread is woken up by the timer interrupt. Afterwards, the VCPU thread may enter the Guest mode from the host side.

FIG. 2 illustrates a schematic flowchart II of live migration of the virtual machine provided by the embodiments of the present disclosure. In the embodiments of the present disclosure, the MWAIT instruction is used as an example and the method for waking up the VCPU thread through the timer interrupt is described below. As shown in FIG. 2, the method for live migration of the virtual machine also may comprise:

S201: creating a timer corresponding to the target VCPU thread and setting an expiry time of the timer.

In the embodiments of the present disclosure, when the target VCPU thread executes the MWAIT instruction to exit to the host side to give up the CPU resources, a timer is created, wherein an expiry time of the timer may be set to a fixed time, such as 1 ms, 2 ms and 4 ms etc. In the embodiments of the present disclosure, the value of the expiry time is not specifically defined and may be set and modified according to the requirements.

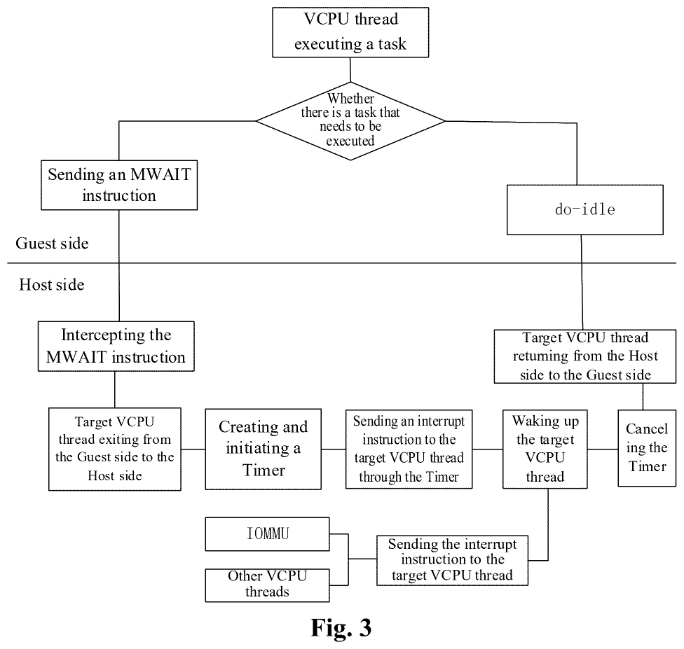

As an example, according to FIG. 3, upon receiving the MWAIT instruction, the target VCPU thread exits from the Guest mode to the host side. At this moment, a timer is created and initiated, wherein the timer may be hrtimer (high resolution timer).

S202: sending, in response to current time reaching the expiry time of the timer, an interrupt instruction to the target VCPU thread via the timer.

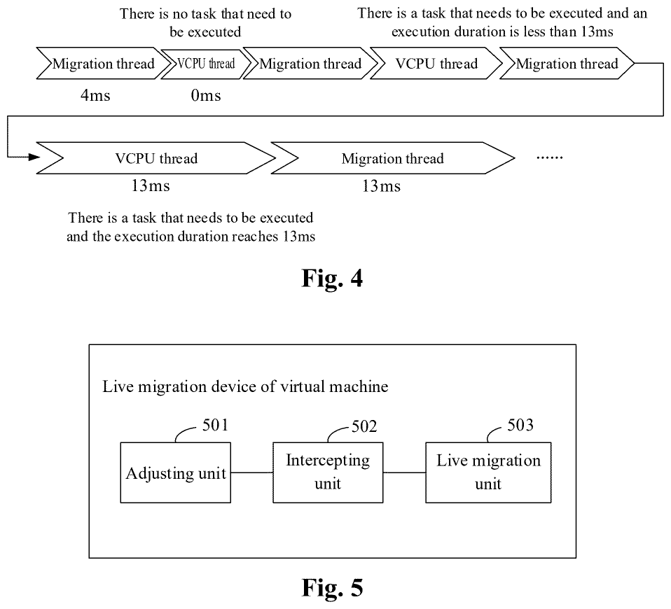

As an example, according to FIG. 4, the expiry time is 1 ms or 4 ms. In response to the current time reaching the expiry time (1 ms or 4 ms) of the timer, the interrupt instruction is sent to the target VCPU thread via the timer.

S203: stopping the live migration thread by the scheduler at the host side and switching the target VCPU thread in the sleep state to a working state through the interrupt instruction, to return the target VCPU thread from the host side to the client side.

In the embodiments of the present disclosure, the target VCPU thread in the sleep state may be woken up by the interrupt instruction and the scheduler at the host side directly preempts the running migration thread (i.e., the live migration thread is stopped by the scheduler at the host side). At this point, the target VCPU thread enters the Guest mode from the host side.

As an example, according to FIG. 3, after the interrupt instruction is sent to the target VCPU thread through the timer, the timer corresponding to the target VCPU thread may be canceled or deleted.

In the embodiments of the present disclosure, when the interrupt instruction is sent to the target VCPU thread by the timer, the target VCPU thread may be woken up to enter the Guest mode from the host side. This avoids the technical problem that when the VCPU thread in the idle state is woken up by the memory monitored by write monitor, the host side could not perceive it and the target VCPU thread could not be woken up.

Furthermore, the target VCPU thread, after being woken up by the timer, may have or may not have tasks to process. Correspondingly, after the target VCPU thread is returned to the client side from the host side, the method further comprises: determining whether the target VCPU thread has a task that needs to be executed; executing, in response to determining that the target VCPU thread has the task that needs to be executed, the task through the target VCPU thread, or sending, in response to determining that the target VCPU thread does not have the task, the MWAIT sleep instruction to the target VCPU thread.

As an example, according to FIG. 3, it is determined via a do-idle instruction whether the target VCPU thread has a task that needs to be executed; if not, the MWAIT sleep instruction is sent to the target VCPU. At this point, the method continues to perform steps 102-104.

In the embodiments of the present disclosure, when the target VCPU has no tasks to perform, the CPU resources of the target VCPU may be freed up again to enhance the processing efficiency of the live migration thread.

Further, if it is decided that the target VCPU thread needs to execute a task, it is determined in accordance with the time for executing the task whether the target VCPU thread is suspended via the scheduler at the host side, to avoid the live migration thread lacking available CPU resources for a long time. The scenario in which a task is to be executed is divided into two cases below for description.

First case: in response to execution of the task by the target VCPU thread is completed and the execution duration is less than a first preset duration, the MWAIT sleep instruction is sent to the target VCPU thread.

In the embodiments of the present disclosure, the value of the first preset duration is not specifically defined and may be set and modified according to the requirements.

As an example, according to FIG. 4, the first preset duration is 13 ms. In response to execution of the task by the target VCPU thread is completed and the execution duration is 5 ms, which is smaller than 13 ms, the MWAIT sleep instruction is sent to the target VCPU thread to free up the CPU resources again for migration thread to use.

Second case: in response to the execution of the task by the target VCPU thread being not completed but the execution duration having reached the first preset duration, the target VCPU thread is suspended by the scheduler at the host side and the live migration thread is initiated. In response to the execution of the live migration task by the live migration thread is not completed but the execution duration has reached a second preset duration, the live migration thread is suspended via the scheduler at the host side and the target VCPU thread is initiated; the live migration thread and the target VCPU thread are alternately suspended by the scheduler at the host side until the execution of the task of the live migration thread is completed or the execution of the task of the target VCPU is completed.

In the embodiments of the present disclosure, the value of the second preset duration is not specifically defined and may be set and modified according to the requirements.

As an example, according to FIG. 4, the first preset duration is 13 ms and the second preset duration is 13 ms. In response to the execution of the task by the target VCPU thread not being completed but the execution duration reaching 13 ms, the target VCPU thread is suspended by the scheduler at the host side and the live migration thread is initiated.

In response to the execution of the live migration task by the live migration thread is not completed but the execution duration reaches 13 ms, the live migration thread is suspended by the scheduler at the host side and the target VCPU thread is initiated.

The live migration thread and the target VCPU thread are alternately suspended by the scheduler at the host side until one of the threads finishes.

In the embodiments of the present disclosure, CPU usage of migration thread=100%−actual usage of VCPU. As such, during the off-peak period (i.e., low CPU usage) of the VCPU thread, the migration thread can take full advantage of the idle CPU resources of the VCPU thread. Therefore, while the VM migration efficiency is improved, there will be almost no obvious jitters on the VM performance during the migration of the VM.

Further, as shown in FIG. 3, the sleep instruction may be HLT (processor halt) instruction or MWAIT instruction; at this point, the interrupt instruction may be sent to the target VCPU thread via an input-output memory management unit (IOMMU) or the interrupt instruction may be sent to the target VCPU thread from other VCPU threads, to wake up the target VCPU thread. Correspondingly, the method further comprises:
stopping, in response to receiving an interrupt instruction sent to the target VCPU thread from IOMMU (I/O Memory Management Unit) or an interrupt instruction sent to the target VCPU thread from other VCPU threads, the live migration thread by the scheduler at the host side; and switching the target VCPU thread in the sleep state to a working state via the interrupt instruction, to return the target VCPU thread from the host side to the client side.

Wherein the interrupt instruction sent to the target VCPU thread from other VCPU threads may be IPI (Inter-Processor Interrupt).

It is to be explained that the intercept switch may be turned off at the completion of the live migration in the embodiments of the present disclosure. At this point, the intercept switch will not intercept the sleep instruction and the VCPU thread will not exit to the host side. Instead, the running VCPU thread in the virtual machine is directly switched to the sleep state at the client side.

Correspondingly, the method further comprises: adjusting, in response to completing the live migration of the virtual machine through the live migration thread, the intercept switch for intercepting the sleep instruction to OFF state.

In the embodiments of the present disclosure, the intercept switch may be flexibly turned on or off in accordance with the execution of the live migration thread, so as to control whether the VCPU thread should free up idle CPU resources.

FIG. 5 illustrates a structural diagram of a device for live migration of the virtual machine provided by embodiments of the present disclosure. As shown in FIG. 5, the device for live migration of the virtual machine comprises:
an adjusting unit 501 for, adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
an intercepting unit 502 for, intercepting, in response to receiving the sleep instruction for a target VCPU thread, the sleep instruction, wherein the target VCPU thread is any VCPU thread in a plurality of VCPU threads running in the virtual machine;
a live migration unit 503 for exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In accordance with one or more embodiments of the present disclosure, the sleep instruction is a processor wait MWAIT sleep instruction; and the device further comprises: a switching unit for creating a timer corresponding to the target VCPU thread and setting an expiry time of the timer; sending, in response to current time reaching the expiry time of the timer, an interrupt instruction to the target VCPU thread via the timer; stopping the live migration thread by the scheduler at the host side and switching the target VCPU thread in the sleep state to a working state through the interrupt instruction, to return the target VCPU thread from the host side to the client side.

In accordance with one or more embodiments of the present disclosure, the device further comprises: a determining unit for determining whether the target VCPU thread has a task that needs to be executed; executing, in response to determining that the target VCPU thread has the task that needs to be executed, the task through the target VCPU thread, or sending, in response to determining that the target VCPU thread does not have the task, the MWAIT sleep instruction to the target VCPU thread.

In accordance with one or more embodiments of the present disclosure, the device further comprises: a scheduling unit for, sending, in response to execution of the task by the target VCPU thread being completed and an execution duration being less than a first preset duration, the MWAIT sleep instruction to the target VCPU thread; or, suspending, in response to the execution of the task by the target VCPU thread not being completed but an execution duration reaching the first preset duration, the target VCPU thread by the scheduler at the host side and initiating the live migration thread, or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed

In accordance with one or more embodiments of the present disclosure, the sleep instruction is a processor halt HLT sleep instruction or an MWAIT sleep instruction; and the device further comprises: a switching unit for, stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; switching the target VCPU thread in the sleep state to a working state via the interrupt instruction, to return the target VCPU thread from the host side to the client side.

In accordance with one or more embodiments of the present disclosure, the device further comprises: an adjusting unit for, adjusting, in response to completing the live migration of the virtual machine through the live migration thread, the intercept switch for intercepting the sleep instruction to OFF state.

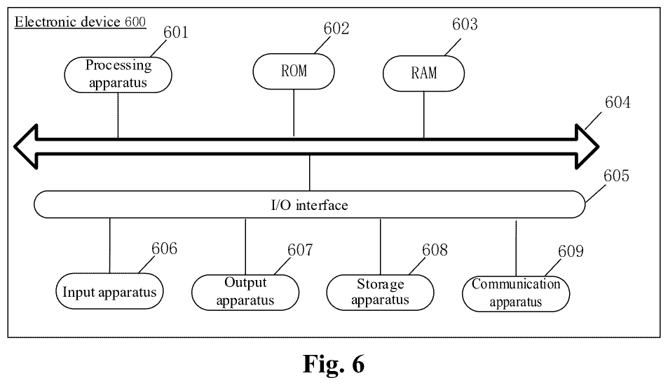

FIG. 6 illustrates a structural diagram of an electronic device 600 adapted to implement embodiments of the present disclosure. The electronic device 600 may be a terminal device or a server, wherein the terminal device may include, but not limited to, mobile terminals, such as mobile phones, notebooks, digital broadcast receivers, Personal Digital Assistant (PDA), Portable Android Device (PAD), Portable Multimedia Player (PMP) and vehicle terminals (such as car navigation terminal) and fixed terminals, e.g., digital TVs and desktop computers etc. The electronic device shown in FIG. 6 is just an example and will not put any restrictions on the functions and application ranges of the embodiments of the present disclosure.

According to FIG. 6, the electronic device 600 may include a processing apparatus (e.g., central processor, graphic processor and the like) 601, which can execute various suitable actions and processing based on the programs stored in the read-only memory (ROM) 602 or programs loaded in the random-access memory (RAM) 603 from a storage apparatus 608. The RAM 603 can also store all kinds of programs and data required by the operations of the electronic device 600. Processing apparatus 601, ROM 602 and RAM 603 are connected to each other via a bus 604. The input/output (I/O) interface 605 is also connected to the bus 604.

Usually, input apparatus 606 (including touch screen, touchpad, keyboard, mouse, camera, microphone, accelerometer, gyroscope and like) and output apparatus 607 (including liquid crystal display (LCD), speaker and vibrator etc.), storage apparatus 608 (including tape and hard disk etc.) and communication apparatus 609 may be connected to the I/O interface 605. The communication apparatus 609 may allow the electronic device 1100 to exchange data with other devices through wired or wireless communications. Although FIG. 6 illustrates the electronic device 600 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a computer readable medium, wherein the computer programs include program codes for executing the method demonstrated by the flowchart. In these embodiments, the computer programs may be loaded and installed from networks via the communication apparatus 609, or installed from the storage apparatus 608, or installed from the ROM 602. The computer programs, when executed by the processing apparatus 601, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer-readable medium carriers one or more programs, where the one or more programs, when executed by the electronic device, cause the electronic device to perform the method shown by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit that obtains at least two internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In a first aspect, according to one or more embodiments of the present disclosure, there is provided a method for live migration of a virtual machine, comprising:
adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
intercepting, in response to receiving the sleep instruction for a target VCPU thread, the sleep instruction, wherein the target VCPU thread is any VCPU thread in a plurality of VCPU threads running in the virtual machine;
exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In accordance with one or more embodiments of the present disclosure, the sleep instruction is a processor wait MWAIT sleep instruction; and the method further comprises: creating a timer corresponding to the target VCPU thread and setting an expiry time of the timer; sending, in response to current time reaching the expiry time of the timer, an interrupt instruction to the target VCPU thread via the timer; stopping the live migration thread by the scheduler at the host side and switching the target VCPU thread in the sleep state to a working state through the interrupt instruction, to return the target VCPU thread from the host side to the client side.

In accordance with one or more embodiments of the present disclosure, after returning the target VCPU thread from the host side to the client side, the method further comprises: determining whether the target VCPU thread has a task that needs to be executed; executing, in response to determining that the target VCPU thread has the task that needs to be executed, the task through the target VCPU thread, or sending, in response to determining that the target VCPU thread does not have the task, the MWAIT sleep instruction to the target VCPU thread.

In accordance with one or more embodiments of the present disclosure, the method further comprises: sending, in response to execution of the task by the target VCPU thread being completed and an execution duration being less than a first preset duration, the MWAIT sleep instruction to the target VCPU thread; or suspending, in response to the execution of the task by the target VCPU thread not being completed but an execution duration reaching the first preset duration, the target VCPU thread by the scheduler at the host side and initiating the live migration thread or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed.

In accordance with one or more embodiments of the present disclosure, the sleep instruction is a processor halt HLT sleep instruction or an MWAIT sleep instruction; and the method further comprises: stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; switching the target VCPU thread in the sleep state to a working state via the interrupt instruction, to return the target VCPU thread from the host side to the client side.

In accordance with one or more embodiments of the present disclosure, the method further comprises: adjusting, in response to completing the live migration of the virtual machine through the live migration thread, the intercept switch for intercepting the sleep instruction to OFF state.

In a second aspect, according to one or more embodiments of the present disclosure, there is provided a device for live migration of a virtual machine, comprising:
an adjusting unit for, adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
an intercepting unit for, intercepting, in response to receiving the sleep instruction for a target VCPU thread, the sleep instruction, wherein the target VCPU thread is any VCPU thread in a plurality of VCPU threads running in the virtual machine;
a live migration unit for exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

In accordance with one or more embodiments of the present disclosure, the sleep instruction is a processor wait MWAIT sleep instruction; and the device further comprises: a switching unit for creating a timer corresponding to the target VCPU thread and setting an expiry time of the timer; sending, in response to current time reaching the expiry time of the timer, an interrupt instruction to the target VCPU thread via the timer; stopping the live migration thread by the scheduler at the host side and switching the target VCPU thread in the sleep state to a working state through the interrupt instruction, to return the target VCPU thread from the host side to the client side.

In accordance with one or more embodiments of the present disclosure, the device further comprises: a determining unit for determining whether the target VCPU thread has a task that needs to be executed; executing, in response to determining that the target VCPU thread has the task that needs to be executed, the task through the target VCPU thread, or sending, in response to determining that the target VCPU thread does not have the task, the MWAIT sleep instruction to the target VCPU thread.

In accordance with one or more embodiments of the present disclosure, the device further comprises: a scheduling unit for, sending, in response to execution of the task by the target VCPU thread being completed and an execution duration being less than a first preset duration, the MWAIT sleep instruction to the target VCPU thread; or, suspending, in response to the execution of the task by the target VCPU thread not being completed but an execution duration reaching the first preset duration, the target VCPU thread by the scheduler at the host side and initiating the live migration thread, or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed

In accordance with one or more embodiments of the present disclosure, the sleep instruction is a processor halt HLT sleep instruction or an MWAIT sleep instruction; and the device further comprises: a switching unit for, stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; switching the target VCPU thread in the sleep state to a working state via the interrupt instruction, to return the target VCPU thread from the host side to the client side.

In accordance with one or more embodiments of the present disclosure, the device further comprises: an adjusting unit for, adjusting, in response to completing the live migration of the virtual machine through the live migration thread, the intercept switch for intercepting the sleep instruction to OFF state.

In a third aspect, according to one or more embodiments of the present disclosure, there is provided an electronic device, comprising: at least one processor and a memory;
where the memory stores computer-executable instructions;
the at least one processor executes the computer-executable instructions stored in the memory, such that the at least one processor performs the method for live migration of the virtual machine according to the above first aspect and various possible designs thereof.

In a fourth aspect, according to one or more embodiments of the present disclosure, there is provided a computer-readable storage medium stored with computer-executable instructions, which computer-executable instructions, when executed by a processor, implement the method for live migration of the virtual machine according to the above first aspect and various possible designs thereof.

In a fifth aspect, according to one or more embodiments of the present disclosure, there is provided a computer program product comprising computer programs, which computer programs, when executed by a processor, implement the method for live migration of the virtual machine according to the above first aspect and various possible designs thereof.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/we claim:

1. A method for live migration of a virtual machine, comprising:
adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
intercepting, in response to receiving the sleep instruction for a target VCPU thread, the sleep instruction, wherein the target VCPU thread is any VCPU thread in a plurality of VCPU threads running in the virtual machine; and
exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

2. The method of claim 1, wherein the sleep instruction is a processor wait MWAIT sleep instruction, and the method further comprises:
creating a timer corresponding to the target VCPU thread and setting an expiry time of the timer;
sending, in response to current time reaching the expiry time of the timer, an interrupt instruction to the target VCPU thread via the timer; and
stopping the live migration thread by the scheduler at the host side and switching the target VCPU thread in the sleep state to a working state through the interrupt instruction, to return the target VCPU thread from the host side to the client side.

3. The method of claim 2, wherein after returning the target VCPU thread from the host side to the client side, the method further comprises:
determining whether the target VCPU thread has a task that needs to be executed; and
executing, in response to determining that the target VCPU thread has the task that needs to be executed, the task through the target VCPU thread, or sending, in response to determining that the target VCPU thread does not have the task, the MWAIT sleep instruction to the target VCPU thread.

4. The method of claim 3, wherein the method further comprises:
sending, in response to execution of the task by the target VCPU thread being completed and an execution duration being less than a first preset duration, the MWAIT sleep instruction to the target VCPU thread; or,
suspending, in response to the execution of the task by the target VCPU thread not being completed but an execution duration reaching the first preset duration, the target VCPU thread by the scheduler at the host side and initiating the live migration thread, or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed.

5. The method of claim 1, wherein the sleep instruction is a processor halt HLT sleep instruction or an MWAIT sleep instruction, and the method further comprises:
stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; and
switching the target VCPU thread in the sleep state to a working state via the interrupt instruction, to return the target VCPU thread from the host side to the client side.

6. The method of claim 1, wherein the method further comprises:
adjusting, in response to completing the live migration of the virtual machine through the live migration thread, the intercept switch for intercepting the sleep instruction to OFF state.

7. An electronic device, comprising: a processor and a memory, wherein:
the memory stores computer-executable instructions; and
the processor executes the computer-executable instructions stored in the memory, so as to cause the processor to perform a method for live migration of the virtual machine comprising:
adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
intercepting, in response to receiving the sleep instruction for a target VCPU thread, the sleep instruction, wherein the target VCPU thread is any VCPU thread in a plurality of VCPU threads running in the virtual machine; and
exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

8. The electronic device of claim 7, wherein the sleep instruction is a processor wait MWAIT sleep instruction, and the method further comprises:
creating a timer corresponding to the target VCPU thread and setting an expiry time of the timer;
sending, in response to current time reaching the expiry time of the timer, an interrupt instruction to the target VCPU thread via the timer; and
stopping the live migration thread by the scheduler at the host side and switching the target VCPU thread in the sleep state to a working state through the interrupt instruction, to return the target VCPU thread from the host side to the client side.

9. The electronic device of claim 8, wherein after returning the target VCPU thread from the host side to the client side, the method further comprises:
determining whether the target VCPU thread has a task that needs to be executed; and
executing, in response to determining that the target VCPU thread has the task that needs to be executed, the task through the target VCPU thread, or sending, in response to determining that the target VCPU thread does not have the task, the MWAIT sleep instruction to the target VCPU thread.

10. The electronic device of claim 9, wherein the method further comprises:
sending, in response to execution of the task by the target VCPU thread being completed and an execution duration being less than a first preset duration, the MWAIT sleep instruction to the target VCPU thread; or,
suspending, in response to the execution of the task by the target VCPU thread not being completed but an execution duration reaching the first preset duration, the target VCPU thread by the scheduler at the host side and initiating the live migration thread, or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed.

11. The electronic device of claim 7, wherein the sleep instruction is a processor halt HLT sleep instruction or an MWAIT sleep instruction, and the method further comprises:
stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; and
switching the target VCPU thread in the sleep state to a working state via the interrupt instruction, to return the target VCPU thread from the host side to the client side.

12. The electronic device of claim 7, wherein the method further comprises:
adjusting, in response to completing the live migration of the virtual machine through the live migration thread, the intercept switch for intercepting the sleep instruction to OFF state.

13. A non-transitory computer-readable storage medium, wherein the computer-readable storage medium stores computer-executable instructions, and a processor, when executing the computer-executable instructions, implements a method for live migration of the virtual machine comprising:
adjusting, in response to a live migration operation for a virtual machine at a client side, an intercept switch for intercepting a sleep instruction to ON state, wherein the sleep instruction is used for switching a virtual central processor (VCPU) thread running in the virtual machine to a sleep state at the client side;
intercepting, in response to receiving the sleep instruction for a target VCPU thread, the sleep instruction, wherein the target VCPU thread is any VCPU thread in a plurality of VCPU threads running in the virtual machine; and
exiting the target VCPU thread from the client side to a host side, switching the target VCPU thread to the sleep state at the host side, and controlling a live migration thread by a scheduler at the host side to occupy CPU resources of the target VCPU thread to execute the live migration of the virtual machine.

14. The non-transitory computer-readable storage medium of claim 13, wherein the sleep instruction is a processor wait MWAIT sleep instruction, and the method further comprises:
creating a timer corresponding to the target VCPU thread and setting an expiry time of the timer;
sending, in response to current time reaching the expiry time of the timer, an interrupt instruction to the target VCPU thread via the timer; and
stopping the live migration thread by the scheduler at the host side and switching the target VCPU thread in the sleep state to a working state through the interrupt instruction, to return the target VCPU thread from the host side to the client side.

15. The non-transitory computer-readable storage medium of claim 14, wherein after returning the target VCPU thread from the host side to the client side, the method further comprises:
determining whether the target VCPU thread has a task that needs to be executed; and
executing, in response to determining that the target VCPU thread has the task that needs to be executed, the task through the target VCPU thread, or sending, in response to determining that the target VCPU thread does not have the task, the MWAIT sleep instruction to the target VCPU thread.

16. The non-transitory computer-readable storage medium of claim 15, wherein the method further comprises:
sending, in response to execution of the task by the target VCPU thread being completed and an execution duration being less than a first preset duration, the MWAIT sleep instruction to the target VCPU thread; or,
suspending, in response to the execution of the task by the target VCPU thread not being completed but an execution duration reaching the first preset duration, the target VCPU thread by the scheduler at the host side and initiating the live migration thread, or suspending, in response to execution of a live migration task by the live migration thread not being completed but an execution duration reaching a second preset duration, the live migration thread by the scheduler at the host side and initiating the target VCPU thread, or alternately suspending the live migration thread and the target VCPU thread by the scheduler at the host side until execution of a task of the live migration thread or execution of a task of the target VCPU thread is completed.

17. The non-transitory computer-readable storage medium of claim 13, wherein the sleep instruction is a processor halt HLT sleep instruction or an MWAIT sleep instruction, and the method further comprises:
stopping, in response to receiving an interrupt instruction sent to the target VCPU thread from Input-Output Memory Management Unit (IOMMU) or an interrupt instruction sent to the target VCPU thread from other VCPU threads, the live migration thread by the scheduler at the host side; and
switching the target VCPU thread in the sleep state to a working state via the interrupt instruction, to return the target VCPU thread from the host side to the client side.

18. The non-transitory computer-readable storage medium of claim 13, wherein the method further comprises:
adjusting, in response to completing the live migration of the virtual machine through the live migration thread, the intercept switch for intercepting the sleep instruction to OFF state.
